(19) United States
(12) Patent Application Publication
(10) Pub. No.: US 2014/0092059 A1
(43) Pub. Date: Apr. 3, 2014

(54) TOUCH SENSING DEVICE AND METHOD

(71) Applicant: HON HAI PRECISION INDUSTRY CO., LTD., New Taipei (TW)

(72) Inventors: CHIA-HAO LIN, New Taipei (TW); MENG-CHE HSU, New Taipei (TW)

(21) Appl. No.: 13/932,200

(22) Filed: Jul. 1, 2013

(30) Foreign Application Priority Data
Oct. 3, 2012 (TW) 101136429

(51) Int. Cl. G06F 3/044

(52) U.S. Cl. CPC G06F 3/044
USPC 345/174

(57) ABSTRACT

A touch sensing device capable of accurately detecting a touched position on a touch panel includes a touch panel and a calculation unit. The touch panel having a plurality of horizontal sensing lines and vertical sensing lines generates a plurality of horizontal and vertical sensing signals in response to a touch on the touch panel. The calculation unit determines a touched position on the touch panel according to the horizontal and vertical sensing signals. A touch sensing method is also provided.

### REFERENCE TO RELATED APPLICATIONS

This application claims all benefits accruing under 35 U.S.C. §119 from Taiwan Patent Application No. 101136429, filed on Oct. 3, 2012 in the Taiwan Intellectual Property Office. The contents of the Taiwan Application are hereby incorporated by reference.

### BACKGROUND

1. Technical Field

The disclosure generally relates to touch panels, and particularly relates to touch sensing devices and methods applied to touch panels.

2. Description of Related Art

In recent years, touch panels serving as input devices are gradually applied to various electronic devices such as mobile phones, personal digital assistants (PDAs), and tablet personal computers (tablet PC). When a touch panel serves as an input device, several operation instructions can be applied for instructing an electronic device to perform various operations. For example, sliding on the touch panel means moving, tapping the touch panel once means clicking a left mouse button, tapping the touch panel twice means clicking a right mouse button, and tapping and sliding on the touch panel means dragging. However, in order to perform the foregoing operation instructions smoothly, a touched position at each of time points needs to be accurately detected on the touch panel so that which operation instruction to be performed can be determined. For example, a direction and a distance are determined according to touched positions at successive time points when sliding is performed on the touch panel.

In addition, the touch panel is often used in a portable electronic device, thus power consumption of the touch panel is an important factor that affects efficiency of the electronic device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of a touch sensing device in accordance with one embodiment of the present disclosure.

FIG. 2 is a schematic diagram of a capacitive touch panel.

FIG. 3 is a table showing horizontal and vertical sensing signals generated by a touch panel.

FIG. 4 is a flowchart showing one embodiment of a touch sensing method.

FIG. 5 is a flowchart showing another embodiment of a touch sensing method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

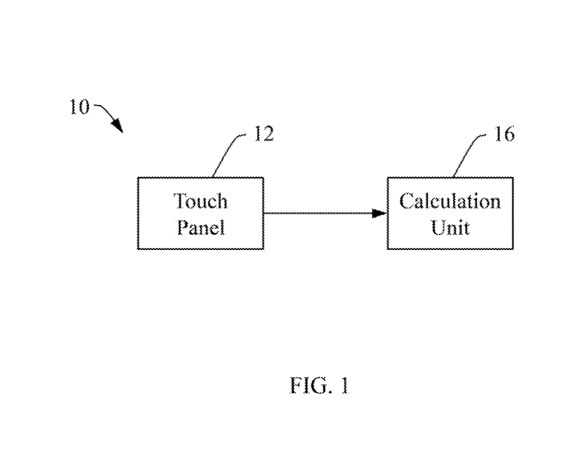

FIG. 1 shows one embodiment of a touch sensing device 10. The touch sensing device 10 includes a touch panel 12 and a calculation unit 16. The touch sensing device 10 serves as an input device of a mobile phone, a personal digital assistant (PDA), a tablet personal computer (tablet PC), or the like.

The touch panel 12 includes a plurality of vertical sensing lines and a plurality of horizontal sensing lines. Each of the vertical sensing lines corresponds to a horizontal coordinate. Each of the horizontal sensing lines corresponds to a vertical coordinate. In other words, the horizontal and vertical sensing lines are alternately distributed on the touch panel 12 to form a two-dimensional (2D) coordinate system.

When a user touches the touch panel 12, the vertical and horizontal sensing lines are respectively sensed to generate corresponding vertical and horizontal sensing signals. The vertical sensing signals represent touch intensities sensed by the touch panel 12 at corresponding horizontal coordinates. The horizontal sensing signals represent touch intensities sensed at corresponding vertical coordinates.

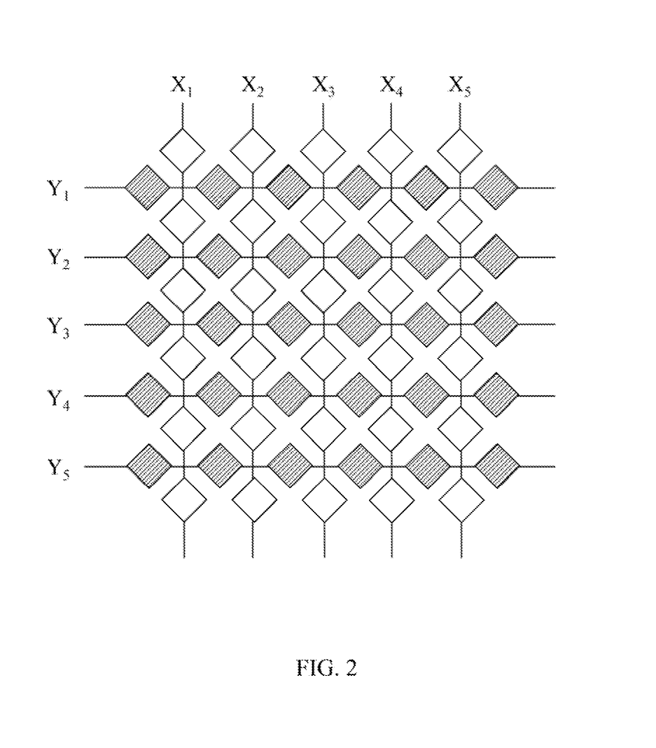

In this embodiment, the touch panel 12 is a capacitive touch panel as illustrated in FIG. 2. The capacitive touch panel 12 comprises n vertical sensing lines and m horizontal sensing lines (e.g. n=m=5 in FIG. 2) corresponding to horizontal coordinates X1 to X5 and vertical coordinates Y1 to Y5. In the capacitive touch panel 12, each of the vertical and horizontal sensing lines possesses an equivalent capacitor. When a user touches the capacitive touch panel 12, capacitance values of the equivalent capacitors are changed, and the vertical and horizontal sensing signals generated by the vertical and horizontal sensing lines represent capacitance variances of equivalent capacitors. As capacitance variance of an equivalent capacitor of a vertical or horizontal sensing line becomes greater, it indicates that a corresponding horizontal or vertical horizontal is closer to the touched position.

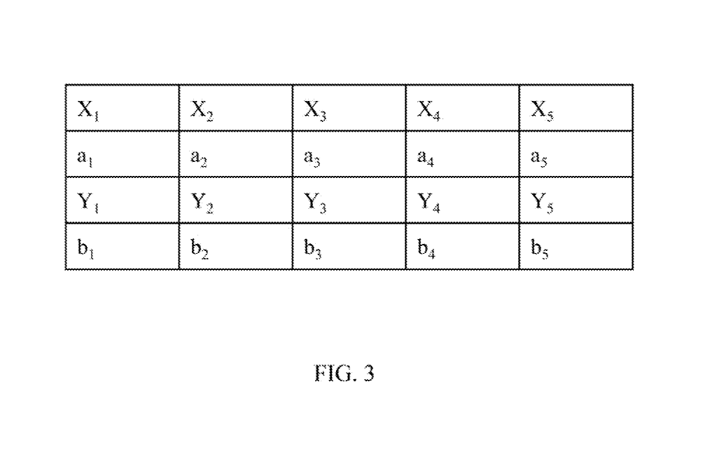

Referring to FIG. 3, an example of a table showing horizontal and vertical sensing signals generated by the touch panel 12 is illustrated. In FIG. 3, five vertical sensing lines corresponding to horizontal coordinates X1 to X5 generate five vertical sensing signals a1 to a5, and five horizontal sensing lines corresponding to vertical coordinates Y1 to Y5 generate five horizontal sensing signals b1 to b5.

The calculation unit 16 is coupled to the touch panel 12. The calculation unit 16 calculates the touched position on the touch panel 12 according to the vertical and horizontal sensing signals generated by the touch panel 12.

In a first embodiment, the calculation unit 16 calculates a horizontal coordinate X and a vertical coordinate Y of the touched position on the touch panel 12 according to the following formulas:

$$X = \frac{{a}_{1} \times {X}_{1} + {a}_{2} \times {X}_{2} + … + {a}_{n} \times {X}_{n}}{{a}_{1} + {a}_{2} + … + {a}_{n}} , \\ Y = \frac{{b}_{1} \times {Y}_{1} + {b}_{2} \times {Y}_{2} + … + {b}_{m} \times {Y}_{m}}{{b}_{1} + {b}_{2} + … + {b}_{m}} ,$$

wherein a₁, a₂, . . . , aₙ represent the plurality of vertical sensing signals generated by the plurality of vertical sensing lines, b₁, b₂, . . . , bₘ represent the plurality of horizontal sensing signals generated by the plurality of horizontal sensing lines, X₁, X₂, . . . , Xₙ represent horizontal coordinates corresponding to the plurality vertical sensing lines, and Y₁, Y₂, . . . , Yₘ represent vertical coordinates corresponding to the plurality of horizontal sensing lines, where n and m are integers greater than two.

In order to reduce need for time-consuming and intermediate data storage, the calculation unit 16 filters the vertical and horizontal sensing signals generated by the touch panel 12 before the calculation of the touched position. The calculation unit 16 may define a vertical threshold and a horizontal threshold. The calculation unit 16 compares each of the vertical sensing signals with the vertical threshold, and compares each of the horizontal sensing signals with the horizontal threshold. The calculation unit 16 discards any vertical sensing signal which is smaller than the vertical threshold, and discards any horizontal sensing signal which is smaller than the horizontal threshold. The discarded sensing signals do not participate in the calculation of the touched position. Thus, noise components contained in the vertical and horizontal sensing signals are relieved.

In a second embodiment, the calculation unit 16 selects the top largest vertical sensing signals, r, from the plurality of vertical sensing signals generated by the plurality of vertical sensing lines, and selects the top largest horizontal sensing signals, s, from the plurality of horizontal sensing signals generated by the plurality of horizontal sensing lines (where r and s are integers greater than two). The calculation unit 16 calculates a horizontal coordinate X and a vertical coordinate Y of the touched position on the touch panel 12 according to the following formulas:

$$X = \frac{{A}_{1} \times {X}_{1} + {A}_{2} \times {X}_{2} + … + {A}_{r} \times {X}_{r}}{{A}_{1} + {A}_{2} + … + {A}_{r}} , \\ Y = \frac{{B}_{1} \times {Y}_{1} + {B}_{2} \times {Y}_{2} + … + {B}_{s} \times {Y}_{s}}{{B}_{1} + {B}_{2} + … + {B}_{s}} ,$$

wherein A₁, A₂, . . . , Aᵣ represent the top r largest vertical sensing signals selected from the plurality of vertical sensing signals generated by the plurality of vertical sensing lines, B₁, B₂, . . . , Bₛ represent the top s largest horizontal sensing signals selected from the plurality of horizontal sensing signals generated by the plurality of horizontal sensing lines, X₁, X₂, . . . , Xᵣ represent horizontal coordinates corresponding to the vertical sensing lines corresponding to the selected top largest vertical sensing signals, r, and Y₁, Y₂, . . . , Yₛ represent vertical coordinates corresponding to the horizontal sensing lines corresponding to the selected top largest horizontal sensing signals, s, where r and s are integers greater than two.

After calculating the horizontal and vertical coordinates of the touched position, the calculation unit 16 transmits the information to a microprocessor (not shown) in an electronic device, so as to interpret the information (e.g. moving or dragging) to perform a corresponding operation accordingly.

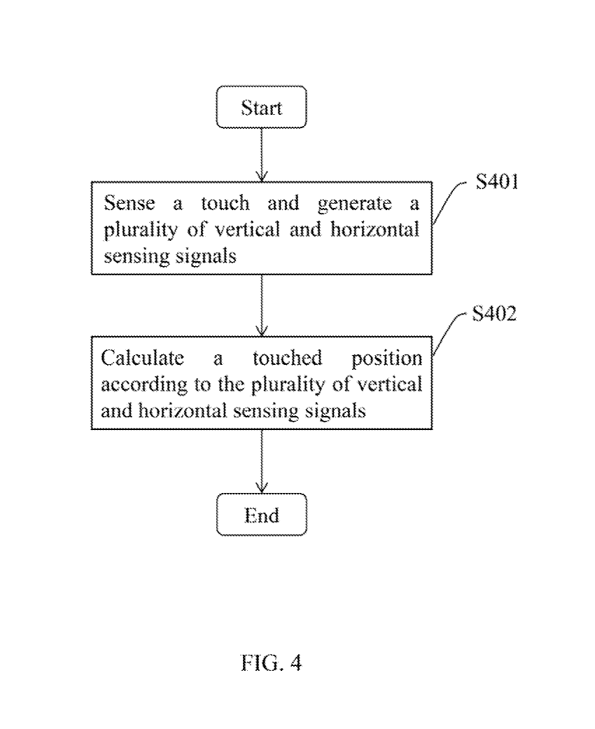

FIG. 4 is a flowchart showing one embodiment of a touch sensing method. The method includes the following steps.

In step S401, the touch panel 12 senses a touch. The horizontal and vertical sensing lines of the touch panel 12 generate a plurality of vertical and horizontal sensing signals.

In step S402, the calculation unit 16 calculates a horizontal coordinate X and a vertical coordinate Y of a touched position on the touch panel 12 according to the following formulas:

$$X = \frac{{a}_{1} \times {X}_{1} + {a}_{2} \times {X}_{2} + … + {a}_{n} \times {X}_{n}}{{a}_{1} + {a}_{2} + … + {a}_{n}} , \\ Y = \frac{{b}_{1} \times {Y}_{1} + {b}_{2} \times {Y}_{2} + … + {b}_{m} \times {Y}_{m}}{{b}_{1} + {b}_{2} + … + {b}_{m}} ,$$

wherein a₁, a₂, . . . , aₙ represent the plurality of vertical sensing signals generated by the plurality of vertical sensing lines, b₁, b₂, . . . , bₘ represent the plurality of horizontal sensing signals generated by the plurality of horizontal sensing lines, X₁, X₂, . . . , Xₙ represent horizontal coordinates corresponding to the plurality vertical sensing lines, and Y₁, Y₂, . . . , Yₘ represent vertical coordinates corresponding to the plurality of horizontal sensing lines, where n and m are integers greater than two.

In order to reduce need for data storage, the calculation unit 16 filters the vertical and horizontal sensing signals generated by the touch panel 12 before the calculation of the touched position. The calculation unit 16 defines a vertical threshold and a horizontal threshold. The calculation unit 16 compares each of the vertical sensing signals with the vertical threshold, and compares each of the horizontal sensing signals with the horizontal threshold. The calculation unit 16 discards any vertical sensing signal which is smaller than the vertical threshold, and any horizontal sensing signal which is smaller than the horizontal threshold. The discarded sensing signals do not participate in the calculation of the touched position. Thus, noise components contained in the vertical and horizontal sensing signals are relieved.

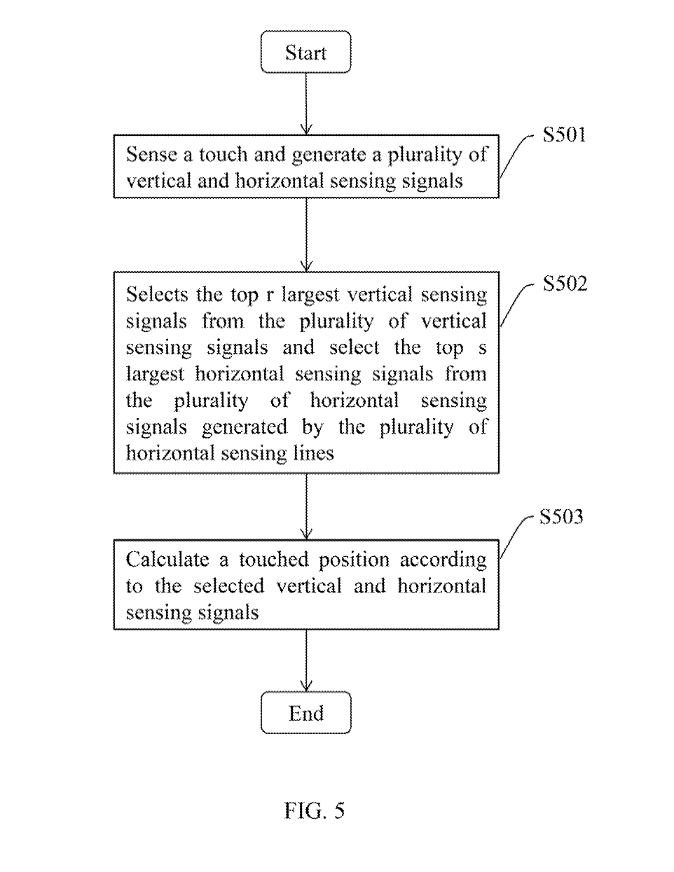

FIG. 5 is a flowchart showing another embodiment of a touch sensing method. The method includes the following steps.

In step S501, the touch panel 12 senses a touch. The horizontal and vertical sensing lines of the touch panel 12 generate a plurality of vertical and horizontal sensing signals.

In step S502, the calculation unit 16 selects the top largest vertical sensing signals, r, from the plurality of vertical sensing signals generated by the plurality of vertical sensing lines, and selects the top largest horizontal sensing signals, s, from the plurality of horizontal sensing signals generated by the plurality of horizontal sensing lines (where r and s are integers greater than two).

In step S502, the calculation unit 16 calculates a horizontal coordinate X and a vertical coordinate Y of the touched position on the touch panel 12 according to the following formulas:

$$X = \frac{{A}_{1} \times {X}_{1} + {A}_{2} \times {X}_{2} + … + {A}_{r} \times {X}_{r}}{{A}_{1} + {A}_{2} + … + {A}_{r}} , \\ Y = \frac{{B}_{1} \times {Y}_{1} + {B}_{2} \times {Y}_{2} + … + {B}_{s} \times {Y}_{s}}{{B}_{1} + {B}_{2} + … + {B}_{s}} ,$$

wherein A₁, A₂, . . . , Aᵣ represent the top r largest vertical sensing signals selected from the plurality of vertical sensing signals generated by the plurality of vertical sensing lines, B₁, B₂, . . . , Bₛ represent the top s largest horizontal sensing signals selected from the plurality of horizontal sensing signals generated by the plurality of horizontal sensing lines, Xᵢ, X₂, . . . , Xᵣ represent horizontal coordinates corresponding to the vertical sensing lines corresponding to the selected top largest vertical sensing signals, r, and Yᵢ, Y₂, . . . , Yₛ represent vertical coordinates corresponding to the horizontal sensing lines corresponding to the selected top largest horizontal sensing signals, s, where r and s are integers greater than two.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered.

The description and the claims drawn for or in relation to a method may give some indication in reference to certain steps. However, any indication given is only to be viewed for identification purposes, and is not necessarily a suggestion as to an order for the steps.

What is claimed is:

1. A touch sensing device, comprising:
a touch panel, comprising a plurality of horizontal sensing lines and a plurality of vertical sensing lines, for generating a plurality of horizontal sensing signals and a plurality of vertical sensing signals in response to a touch on the touch panel; and
a calculation unit, coupled to the touch panel, for calculating a horizontal coordinate X and a vertical coordinate Y of a touched position on the touch panel according to the following formulas:
$$X = \frac{{a}_{1} \times {X}_{1} + {a}_{2} \times {X}_{2} + … + {a}_{n} \times {X}_{n}}{{a}_{1} + {a}_{2} + … + {a}_{n}} , \\ Y = \frac{{b}_{1} \times {Y}_{1} + {b}_{2} \times {Y}_{2} + … + {b}_{m} \times {Y}_{m}}{{b}_{1} + {b}_{2} + … + {b}_{m}} ,$$
wherein
a₁, a₂, . . . , aₙ represent the plurality of vertical sensing signals generated by the plurality of vertical sensing lines,
b₁, b₂, . . . , bₘ represent the plurality of horizontal sensing signals generated by the plurality of horizontal sensing lines,
X₁, X₂, . . . , Xₙ represent horizontal coordinates corresponding to the plurality vertical sensing lines, and
Y₁, Y₂, . . . , Yₘ represent vertical coordinates corresponding to the plurality of horizontal sensing lines, n and m are integers greater than two.

2. The touch sensing device of claim 1, wherein the calculation unit is further adapted to compare each of the plurality of vertical sensing signals with a vertical threshold and discard any vertical sensing signal which is smaller than the vertical threshold.

3. The touch sensing device of claim 1, wherein the calculation unit is further adapted to compare each of the plurality of horizontal sensing signals with a horizontal threshold and discard any horizontal sensing signal which is smaller than the horizontal threshold.

4. The touch sensing device of claim 1, wherein the touch panel is a capacitive touch panel.

5. A touch sensing device, comprising:
a touch panel, comprising a plurality of horizontal sensing lines and a plurality of vertical sensing lines, for generating a plurality of horizontal sensing signals and a plurality of vertical sensing signals in response to a touch on the touch panel; and
a calculation unit, coupled to the touch panel, for selecting the top largest vertical sensing signals, r, from the plurality of vertical sensing signals and the top largest horizontal sensing signals, s, from the plurality of horizontal sensing signals, and calculating a horizontal coordinate X and a vertical coordinate Y of the touched position on the touch panel according to the following formulas:
$$X = \frac{{A}_{1} \times {X}_{1} + {A}_{2} \times {X}_{2} + … + {A}_{r} \times {X}_{r}}{{A}_{1} + {A}_{2} + … + {A}_{r}} , \\ Y = \frac{{B}_{1} \times {Y}_{1} + {B}_{2} \times {Y}_{2} + … + {B}_{s} \times {Y}_{s}}{{B}_{1} + {B}_{2} + … + {B}_{s}} ,$$
wherein
A₁, A₂, . . . , Aᵣ represent the top r largest vertical sensing signals selected from the plurality of vertical sensing signals generated by the plurality of vertical sensing lines,
B₁, B₂, . . . , Bₛ represent the top s largest horizontal sensing signals selected from the plurality of horizontal sensing signals generated by the plurality of horizontal sensing lines,
X₁, X₂, . . . , Xᵣ represent horizontal coordinates corresponding to the vertical sensing lines corresponding to the selected top largest vertical sensing signals, r, and
Y₁, Y₂, . . . , Yₛ represent vertical coordinates corresponding to the horizontal sensing lines corresponding to the selected top largest horizontal sensing signals, s, wherein r and s are integers greater than two.

6. The touch sensing device of claim 1, wherein the touch panel is a capacitive touch panel.

7. A touch sensing method, comprising:
sensing a touch on a touch panel to generate a plurality of horizontal sensing signals and a plurality of vertical sensing signals, wherein each of the horizontal sensing signals corresponds to a vertical coordinate and each of the vertical sensing signals corresponds to a horizontal coordinate; and
calculating a horizontal coordinate X and a vertical coordinate Y of a touched position on the touch panel according to the following formulas:
$$X = \frac{{a}_{1} \times {X}_{1} + {a}_{2} \times {X}_{2} + … + {a}_{n} \times {X}_{n}}{{a}_{1} + {a}_{2} + … + {a}_{n}} , \\ Y = \frac{{b}_{1} \times {Y}_{1} + {b}_{2} \times {Y}_{2} + … + {b}_{m} \times {Y}_{m}}{{b}_{1} + {b}_{2} + … + {b}_{m}} ,$$
wherein
a₁, a₂, . . . , aₙ represent the plurality of vertical sensing signals,
b₁, b₂, . . . , bₘ represent the plurality of horizontal sensing signals,
X₁, X₂, . . . , Xₙ represent horizontal coordinates corresponding to the plurality vertical sensing signals, and
Y₁, Y₂, . . . , Yₘ represent vertical coordinates corresponding to the plurality of horizontal sensing signals, n and m are integers greater than two.

8. The touch sensing method of claim 7, further comprising:
comparing each of the plurality of vertical sensing signals with a vertical threshold; and
discarding any vertical sensing signal which is smaller than the vertical threshold.

9. The touch sensing method of claim 7, further comprising:
comparing each of the plurality of horizontal sensing signals with a horizontal threshold; and
discard any horizontal sensing signal which is smaller than the horizontal threshold.

10. The touch sensing method of claim 7, wherein the touch panel comprises a plurality of horizontal sensing lines capable of generating the plurality of horizontal sensing signals, and a plurality of vertical sensing lines capable of generating the plurality of vertical sensing signals;

11. The touch sensing method of claim 7, wherein the touch panel is a capacitive touch panel.
